(19) United States
(12) Patent Application Publication
(10) Pub. No.: US 2004/0225633 A1
(43) Pub. Date: Nov. 11, 2004

(54) Using pure HTML to access database without refreshing page

(75) Inventor: Jack Jau, Hsin-chu (TW)

Correspondence Address: STEPHEN B. ACKERMAN, 28 DAVIS AVENUE, POUGHKEEPSIE, NY, 12603, US

(73) Assignee: Taiwan Semiconductor Manufacturing Co.

(21) Appl. No.: 10/434,740

(22) Filed: May 8, 2003

(51) Int. Cl. G06F 17/30

(52) U.S. Cl. 707/1; 715/530

(57) ABSTRACT

A method and system of accessing databases from Web pages using pure HTML without the need to install special client code. It avoids the many page refreshes required in many implementations and works in most environments. It separates the common scripts into server side and client side. In doing so, it lets the server side do the database accessing while the client side asks for the data and displays it.

### BACKGROUND OF THE INVENTION

1. Field of Invention This invention relates generally to the Internet Web environment and, more particularly to the saving of access time to the data by eliminating the need to refresh the page for most data accesses.

2. Description of Related Art

In the Internet Web environment, browsers display the coded HTML language page for the user at the client Personal Computer (PC). When a page is interactive in that it allows the user to enter or ask for information from a database, significant data transfer over the network can be required. This transfer takes time and can slow down an application and make it harder to use due to wait time. Additionally, using database environments like ODBC, DB2 and Oracle can require the installation of their client code on every client PC.

In U.S. Pat. No. 6,209,029 (Epstein et al.) a method and apparatus for accessing data sources in a three-tier environment is discussed. In U.S. Pat. No. 6,239,797 (Hills et al.) a method and apparatus for remote database record scrolling and updating without refreshing is discussed. In U.S. Pat. No. 5,965,709 (Xue) a dynamic data assembling method on the Internet client side is discussed. In U.S. Pat. No. 5,835,712 (DeFresne) a client server system using embedded hypertext tags is discussed.

The new method of this invention provides a simple-to-implement procedure that eliminates the need to install special software on each client and provides improved performance in interactive database environments.

### SUMMARY OF THE INVENTION

This invention's overall objective is to obtain data from databases using HyperText Markup Language (HTML) without need for Web page refresh. A more specific objective is to provide a system and method of separating code into a client side code and a server side script which simplifies and improves the accessing of databases from Web pages. An additional objective is to use code like Javascript to request a server side script to do all the accessing of databases. This relieves the client from having to install any database client code on its system. Another objective is for the server side script to respond to the client side code, writing database access results to its Web browser. A final objective is to provide a reduced need for network activity in database access and return of data.

These objectives are met by the method and system of this invention. This method and system makes it possible to obtain data from databases using HTML without need for additional Web page data round trips and time-consuming page refreshes. The result is more efficient and timely database accessing.

### BRIEF DESCRIPTION OF THE DRAWINGS

This invention will be described with reference to the accompanying drawings, wherein:

FIG. 1 is block diagram showing the prior art method.

FIG. 2 is a block diagram showing the new two-part method.

FIG. 3 is a flow diagram showing the reduction in round trips from the client to the server.

### DETAILED DESCRIPTION OF THE PREFERRED EMBODIMENT

In the Internet Web environment, browsers convert the HTML code language to produce screens that are presented to the user. This HTML code is usually sent to the browser via a PC connected to the Internet or other network. The screens are displayed to the user as the browser interprets the HTML at the speed of the network connection. Simple screens are displayed quickly with the user wait time being short. Complex screens containing graphics can take much longer to display with a much longer wait time for the user as the data is transmitted over the network and interpreted by the browser. Simple screens that do not allow changes on them are called static screens and are placed in browser and server caches for fast display to the user. In the early days of the Internet, most screens were primarily static in content and the amount of data needed to display them was minimal.

Data content of screens has changed greatly as the Internet and the Web have matured. Today most screens contain significant graphics and are coded to display content differently depending on user needs. These pages are called dynamic screens and can take significantly longer for the network to transmit and longer for the browser to interpret and display. The parts of the screen that are changed cannot be cached and must be re-transmitted each time. The user waits during this longer display time and the usability of the screen is reduced until the display is fully completed.

Adding to a longer display time is the additional use of database access from the screens. Screens are coded to allow users to access data from database programs like ODBC, DB2 and Oracle. This is accomplished through the use of the consistent interface that HTML screens provide to the user and can act as a front end interface to the database programs themselves. To allow access to the database programs easily and efficiently, each PC accessing a database program needs to install the client code for that database program. The HTML is coded to call a script program such as the Common Gateway Interface (CGI) that in turn calls the database client code to ask it to access and retrieve the requested data. Currently it takes two round trips across the network between the server and browser to specifically access and respond to the client. Wait time increases with each additional round trip needed. Actions involving database access require Web page refresh causing additional delays. Some applications without a CGI require that a database environment such as ODBC, DB2 client, Oracle client, etc. be installed and configurated on the client in order to access a specific database.

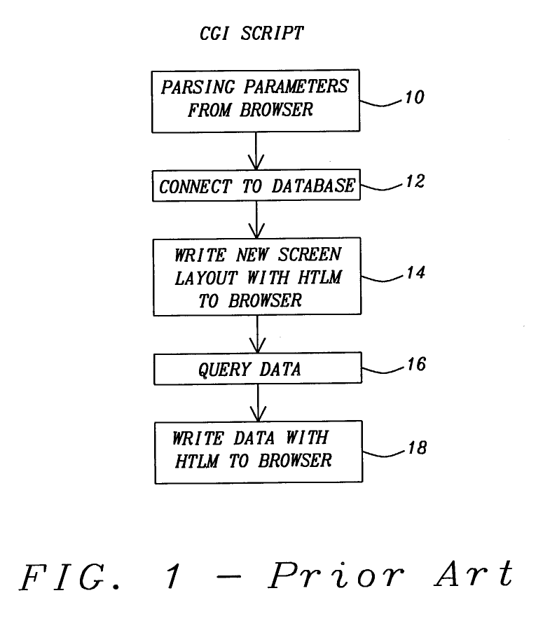

FIG. 1 shows a block diagram of the structure of a CGI Script that accesses the database client. For each piece of data required on the screen, the CGI must start Parsing Parameter From the Browser 10. Once it has determined what data is requested from the database it Connects to the Database client 12 in the format required by that client. The CGI then starts to Write the New Screen Layout with HTML to the Browser 14. A Query Data 16 is issued by the client software and returned to the CGI script. The CGI then Writes Data With HTML to the Browser 18. Thus, two communication round trips have occurred between the client and server.

Besides the delays inherent in this database interaction, the installation and maintenance of the specific database client code is a constant concern. All users must have the database client code installed for them to access the data. That code must be kept current at the right version release level, and there may be a license fee for each PC client installation. A nontrivial process must be developed to ensure users have the proper client code and its updates. A better method is needed to solve these problems. The method and system of this invention minimizes the screen display delays as it requires less network round trips between server and client and no Web page refresh. Additionally, it simplifies maintenance.

To solve the problems of the current method, this new method and system separates code into two pieces: a client side code running on the client and a server side script on the server. They communicate directly with each other as each request is issued. The client side code withy pure HTML acts as a Graphic User Interface (GUI) and the server side script acts as logic. This separation of the GUI and logic allows for simplified code maintenance. Client side code is coded in Javascript or Vbscript to request that the server side script access a specific database. Pure HTML is used to lay out the GUI which is requested and run at a user's browser. This HTML and the Web scripting languages used by the server side script make this method and system platform independent. No database client code is resident in the client PC as all database access code is now resident only on the server CGI. Therefore, zero client install and configuration is needed. The server side script is coded in any of the Web scripting languages and provides the function of the common gateway interface.

A transmission request containing all the specific parameter information necessary for accessing a specific database is sent from the client side code to the server side script. The server side script parses the parameters, accesses the specific database, and writes the database access results back to the client side code and the pure HTML. These results are parsed to get real data and inserted into the Web page. The specific database access transaction has required only one round trip of communication between the Web server and the user's browser compared to the additional round trips previously needed. The separation of code has not only simplified code maintenance but eliminated a need for Web page refresh as only the server side script accessed the database thereby not affecting the client side code. This reduces the need for network activity with the result of less wait time and complexity.

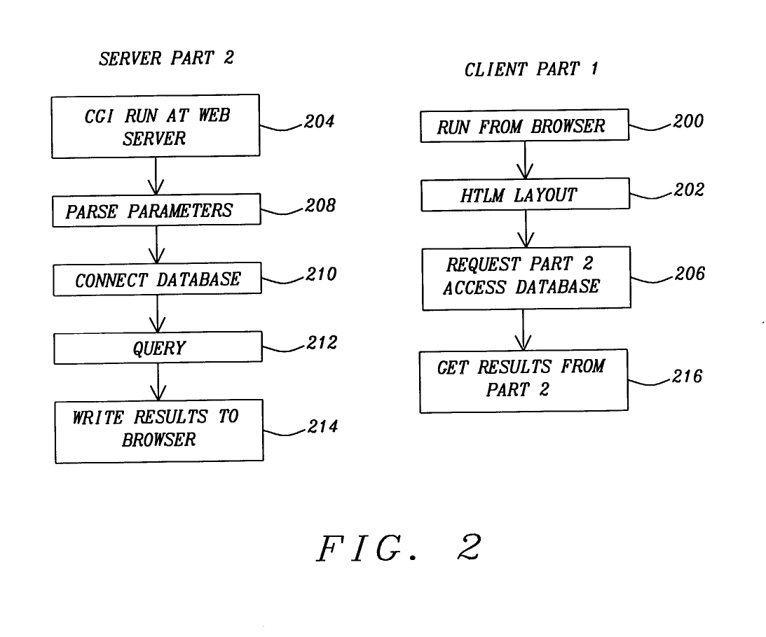

FIG. 2 shows a block diagram of the new method and system with the separated code. The Client Part 1 is coded to Run From the Browser 200. It handles all screen presentation by providing the HTML Layout 202. This is effectively the Graphic User Interface (GUI) side. The Server Part 2 runs a CGI Script at the Web Server 204. This is effectively the logic side. The client part 1 Requests the Server Part 2 to Access the Database 206 and sends along the necessary parameters for the request. Part 2 Parses the Parameters 208 and interprets them and connects to the proper database 210. This can be written to handle a plurality of database types based on the parameters passed to it from part 1. Thus, one server CGI can connect many different databases. Part 2 then does the database Query 212 and Writes the Results to Browser 214. Part 1 Gets the Results from Part 2 216 and can carry out additional functions with it. This has all been done without need for a screen refresh so not only has the user received his data more efficiently, but he hasn't had to wait while his screen redisplays.

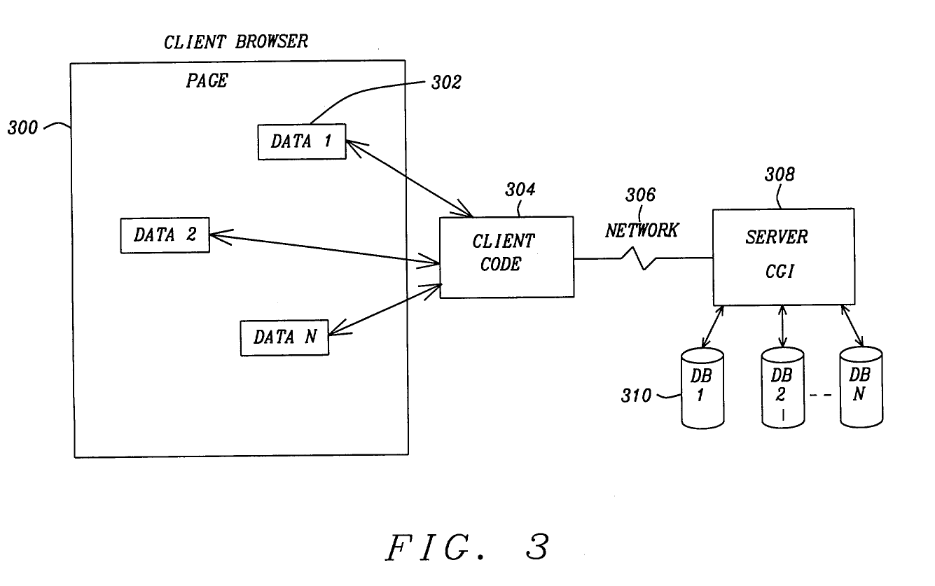

With this method and system of separating the interface logic (GUI) from the program logic it becomes much easier to maintain the code as the client contains only pure HTML, and only one communication round trip has occurred between the server and browser. FIG. 3 illustrates this. On the Client's Browser Page 300, FIG. 3 shows the three data areas Data 1, Data 2, and Data N 302. These are areas that the user is either inputting data or expecting data to return once he clicks on a specific area of the page or perhaps he has pressed the Enter key. The parameters of each data area are sent by the Client Code 304 using HTML with javascript or Vbscript over the Network 306 to the Server CGI 308. This Server CGI then parses the passed parameters, determines from the parameters which databases need to be accessed and then connects and accesses a plurality of databases such as DB1, DB2 through DBN 310. The Server CGI 308 then collects the results and passes them back to the Client Code 304 which parses the results to get real data and displays them on the Client's Browser Page 300. A single communication round trip has been made between the server and browser.

This method and system can be written in any common CGI script-type language such as ASP, JSP, PHP, CGI, etc. The principle is the same to divide the GUI from the logic. The benefits are the same no matter what language is used.

The method and system of the invention provides advantages over the prior art including providing database access with zero client install and configuration, reduced communication round trips between server and client, no need for Web page refresh, and simplified maintenance. This translates into improved responsiveness and efficiency as well as cost and time savings.

While the invention has been particularly shown and described with reference to preferred embodiments thereof, it will be understood by those skilled in the art that various changes in form and details may be made without departing from the spirit and scope of the invention.

What is claimed is:

1. A method for obtaining data from databases using HyperText Markup Language without need for Web page refresh comprising of
a. separating code into a client side code and a server side script;
b. providing for said client side code to request said server side script to do the access to said databases, and
c. providing for said server side script to respond to said client side code with the database access results.
d. providing for reduced need for network activity in database access and return of data.

2. The method for obtaining data from databases of claim 1, wherein the separation of code eliminates said need for Web page refresh as only said server side script accesses the database thereby not affecting said client side code.

3. The method for obtaining data from databases of claim 2, wherein said client side code with HyperText Markup Language acts as a Graphic User Interface and the server side script acts as logic.

4. The method for obtaining data from databases of claim 3, wherein separation of said Graphic User Interface and said logic allows for simplified code maintenance.

5. The method for obtaining data from databases of claim 3, wherein pure said HyperText Markup Language is used to lay out said Graphic User Interface which is requested and run at a user's browser.

6. The method for obtaining data from databases of claim 5, wherein using pure HyperText Markup Language and Web scripting languages enables platform independence allowing the method to be run on any common computer system available.

7. The method for obtaining data from databases of claim 1, wherein said client side code is coded in Javascript or Vbscript to request that said server side script access a specific database.

8. The method for obtaining data from databases of claim 7, wherein a transmission request from said client side code contains all the specific parameter information necessary for accessing said specific database by said server side script.

9. The method for obtaining data from databases of claim 7, wherein the specific parameters are parsed by said server side script and used to access said specific database with access results written back to said client side code.

10. The method for obtaining data from databases of claim 9 wherein said server side script is coded in any one of said Web scripting languages.

11. The method for obtaining data from databases of claim 10, wherein said Web scripting languages run at the server provide the function of the common gateway interface language.

12. The method for obtaining data from databases of claim 11, wherein said common gateway interface language provides for database access with zero client install and configuration eliminating maintenance at the client.

13. The method for obtaining data from databases of claim 9, wherein said results received by said client side code and said HyperText Markup Language are parsed to get real data and inserted into Web page.

14. The method for obtaining data from databases of claim 1, wherein only one round trip is required between the web server and said user's browser for each access of said specific database resulting in said reduced need for network activity.

15. A system for obtaining data from databases using HyperText Markup Language without need for Web page refresh comprising of:
a. a means to separate code into a client side code and a server side script;
b. a means to provide for said client side code to request said server side script to do the access to said databases;
c. a means to provide for said server side script to respond to said client side code with browser with the database access results, and.
d. a means to reduce need for network activity in database access and return of data.

16. The system for obtaining data from databases of claim 15, wherein the separation of code eliminates said need for Web page refresh as only said server side script accesses the database thereby not affecting said client side code.

17. The system for obtaining data from databases of claim 16, wherein said client side code with HyperText Markup Language acts as a Graphic User Interface and the server side script acts as logic.

18. The system for obtaining data from databases of claim 17, wherein separation of said Graphic User Interface and said logic allows for simplified code maintenance.

19. The system for obtaining data from databases of claim 17, wherein using pure HyperText Markup Language and Web scripting languages enables platform independence allowing the method to be run on any common computer system available.

20. The system for obtaining data from databases of claim 19, wherein the use of pure HyperText Markup Language and Web scripting languages makes it platform independent.

21. The system for obtaining data from databases of claim 15, wherein said client side code is coded in Javascript or Vbscript to request that said server side script access a specific database.

22. The system for obtaining data from databases of claim 21, wherein a transmission request from said client side code contains all the specific parameter information necessary for accessing said specific database by said server side script.

23. The system for obtaining data from databases of claim 21, wherein the specific parameters are parsed by said server side script and used to access said specific database with access results written back to said client side code.

24. The system for obtaining data from databases of claim 23 wherein said server side script is coded in any one of said Web scripting languages.

25. The system for obtaining data from databases of claim 24, wherein said Web scripting languages run at the server provide the function of the common gateway interface language.

26. The system for obtaining data from databases of claim 25, wherein said common gateway interface language provides for database access with zero client install and configuration eliminating maintenance at the client.

27. The system for obtaining data from databases of claim 23, wherein said results received by said client side code and said HyperText Markup Language are parsed to get real data and inserted into Web page.

28. The system for obtaining data from databases of claim 15, wherein only one round trip is required between the web server and said user's browser for each access of said specific database resulting in said reduced need for network activity.
